(19) United States
(12) Patent Application Publication
(10) Pub. No.: US 2015/0281362 A1
(43) Pub. Date: Oct. 1, 2015

(54) SYSTEM FOR MOBILE APPLICATION NOTARY SERVICE

(71) Applicant: CELLCO PARTNERSHIP D/B/A VERIZON WIRELESS, BASKING RIDGE, NJ (US)

(72) Inventors: Sankar SHANMUGAM, Dayton, NJ (US); Manmeet KAUR, Iselin, NJ (US); Petri VIRKKULA, Kendall Park, NJ (US)

(73) Assignee: CELLCO PARTNERSHIP D/B/A VERIZON WIRELESS, BASKING RIDGE, NJ (US)

(21) Appl. No.: 14/230,963

(22) Filed: Mar. 31, 2014

(51) Int. Cl. H04L 29/08; H04W 88/02

(52) U.S. Cl. CPC H04L 67/12; H04W 88/02

(57) ABSTRACT

An example of a system that provides notary services on behalf of an application client running on a mobile device is described. The application client requests a notarization token from an application notary service client running on the same mobile device. The application notary service client utilizes a SIM card of the mobile device to generate a notarization token request which is sent to an application notary service server. The application notary service server utilizes a SIM signature validator server to validate the notarization token request and generates the notarization token for delivery to the application client via the application notary service client. The application client includes the notarization token in a request to an application server, which uses the notarization token to validate the application client for access to a function or data of the server.

### BACKGROUND

In recent years, the popularity of smart mobile devices, such as smartphones and tablets, has exploded. Many of the functions that device users utilize on such devices are supported by mobile apps. A mobile app typically involves an application program stored on and executed by the mobile device. Many mobile applications, however, involve an interaction with a server program stored on and executed by server hardware in a network, such as a mobile communications network and/or the Internet. The application program on the mobile device serves as a client to obtain or consume a service offered by a server application running on a network computer platform. Although some types of such client programs, such as browsers, may communicate with a variety of servers to obtain different services, many mobile apps involve interaction of the client program with a specific corresponding server program. A mobile shopping app, for example, might utilize the shopping service vendor's client application program running on the mobile device to enable the mobile device to obtain information from and conduct transactions with a server of that same shopping service vendor. The client application in turn provides the user interface functionalities on the device, albeit as configured by the particular vendor for the shopping service.

Where the service provider offers a mobile app, with a mobile client configured to correspond to and specifically access that provider's server application, it may be undesirable for client applications of other parties to access information from and/or on that provider's server. By way of an example, consider a mobile network service provider that offers a mobile app allowing its device user-customers to access their usage and other account information on-line. Such a provider operates a server application on-line and offers for download a corresponding client application program for execution on the customers' mobile devices. The service provider in our example intends to allow users of its client application program access to the information but may prefer not to allow third party client applications access to the on-line information at the server, even if the other client applications are running on devices of customers of the service provider.

Currently, the backend services accessed via the server are able to check whether a client request originates from a customer device, but not from which application running in the device. For example, third party data meter apps exist in the marketplace for execution on mobile devices. These data meter apps are able to utilize a network service provider's backend service to obtain usage data corresponding to the user of the mobile device (e.g., minutes of use, data transferred, etc.), even if the provider's application server would desire such apps not to be able to access the usage data, because the backend service on the provider's application server cannot distinguish those third party data meter apps from the provider's own mobile app client program.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of an example of a system which may implement a method for providing notary services on behalf of an app running on a mobile device via a platform of a wireless network.

FIG. 2 is a high-level functional block diagram of an example of a client device and servers involved in the method for providing notary services, such as in the system of FIG. 1.

FIG. 3 is a flow diagram of an example of steps involved in the method for providing notary services, such as may be implemented in the system of FIG. 1.

FIG. 4 provides a block diagram illustration of an example of a mobile device.

FIG. 5 provides a block diagram of a general purpose computer hardware platform that may be configured as a host or server, for example, to function as any of the server computers shown in FIG. 1.

FIG. 6 is a simplified functional block diagram of a personal computer or other work station or terminal device

### DETAILED DESCRIPTION OF EXAMPLES

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

A provider of an on-line service for mobile apps may have a desire to be sure that a client application accessing the backend service is known and prevent unauthorized applications from accessing the service. In an example, a server component is able to validate that a request is coming from an authorized client application on a mobile device, and a client application on a mobile device has a mechanism to pass the client application's identity to their server component. In a more specific example, a solution utilizes a subscriber identity or identification module (SIM) card (or other type of a Universal Integrated Circuit Card (UICC)) of the mobile device to sign a response to an application identity, in response to a challenge from the server, to prove the identity of a client application. This solution is performed at the application layer in addition to, and independent of, any identification that may occur between a mobile device and a mobile communications network. Thus, a separate trusted mobile device application notary client, in conjunction with a trusted notary server, provides a notary service to the mobile device client application.

In general, a notary service involves a trusted third party providing identity verification of a first party to a second party. More specifically, as described in greater detail below, a mobile application notary service (i.e., third party) provides identity verification of a mobile device application client (i.e., first party) to an application server (i.e., second party). The mobile application notary service includes an application notary client that utilizes an identity module (e.g., UICC or SIM) of the mobile device to generate a notarization token request on behalf of the mobile device application client and an application notary server to generate a notarization token in response to the notarization token request and validate the notarization token when presented by the application server (after the application server has received the notarization token when the mobile device application client seeks to access that server).

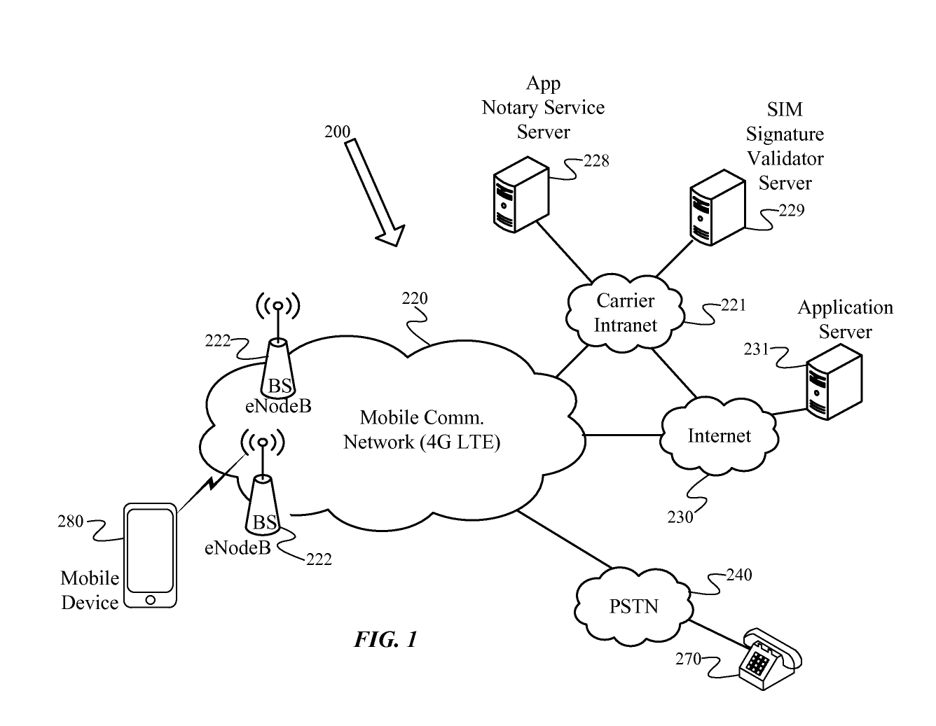

Reference now is made in detail to the examples illustrated in the accompanying drawings and discussed below. FIG. 1 is a functional block diagram of an exemplary system 200 that supports various mobile communication services and which may implement a method for providing notary services on behalf of an app running on a mobile device via a platform of a wireless network.

The illustrated system 200 services any number of mobile devices, including the illustrated Mobile Device 280. Mobile Device 280 may be a laptop, a personal digital assistant (“PDA”), a smartphone, a tablet PC or another portable device designed to communicate via a wireless network. The mobile device 280 in our example corresponds to a smartphone or tablet itself having network communication capability and a user interface, which in this discussion, may be used in the notary services procedures. As discussed in more detail below, the mobile device 280 runs a number of mobile client application programs, one of which attempts to access a corresponding server application using communications through the system of FIG. 1; and that access involves a notary/validation procedure to confirm that the client application program is authorize to access the particular server application.

The illustrated system example includes a mobile communication network 220, in this case, operated in accordance with 4G LTE standards. Mobile network 220 may provide mobile telephone communications as well as Internet data communication services. For example, mobile network 220 may connect to the public switched telephone network (PSTN) 240 (eventually connecting to PSTN device 270) and public packet-switched data communication networks such as the Internet 230. Data communications via mobile network 220 provided for users of devices like 280 may support a variety of services such as communications of text and multimedia messages, e-mail, web browsing, streaming or downloading content, etc. with network connected equipment represented generically by the server 231 in the drawing. Such services may be implemented as an App or client application (not shown) running on mobile device 280 and connecting to an application server, such as server 231. Voice communication also may involve transport via the Internet 230 using voice over Internet Protocol (VoIP) technologies. Mobile Device 280 may connect to mobile network 220 through a cellular base station 222, two of which appear in the drawing by way of example.

For convenience only, the drawings and description use terms like base station (BS) originally developed to describe elements of older mobile network technologies. The terms are used here, however, in a broader sense to also encompass equipment used for similar wireless link and routing/control purposes in more modern network technologies. In a 4G wireless network, for example, each wireless access node corresponding to one of the illustrated base stations may take the form of a node referred to as an eNodeB, and the wireless mobile devices are types of user equipment (UE) devices. Packet routing and control functions may be implemented in packet routers and/or associated server platforms in the radio access network (RAN) or in many cases in elements of an IP Multimedia Service (IMS) core network (not shown separately) coupled to some number of 4G RANs, although such routing and control element(s) are generically included in the broad class of devices that may be used to implement the network functionality discussed here.

The server application may be provided by and run on equipment of another type of service provider, e.g. independent of the operator providing communication services via the network. For purposes of a specific example only, the drawing shows a configuration in which the server application (e.g. on server platform 231) corresponding to a mobile device client application is operated on equipment of a different carrier/operator than the carrier/operator that provides communication services via the network. In a different example (not shown), the server application corresponding to a mobile device client application is operated on equipment of the same carrier/operator that provides communication services via the network. In such an example, the service offered by the relevant mobile app (server application and corresponding client application) represents a service that the carrier offers to its customers, typically, to the users of mobile devices having subscriptions with that communication service provider. That service provider also operates the elements for application validation via the electronic notary service under consideration here.

The carrier that operates the network 220 also utilizes a variety of other systems for related purposes, such as maintenance, accounting and provisioning. In the example, the carrier has another data network, e.g. Intranet 221, that provides data communications for other data systems used by the carrier, and that network 221 has connectivity into the network 220 that provides the actual communications services to the carrier's customers. For purposes of the present discussion, equipment communicating via the network 221 includes an App Notary Service Server 228 as well as a SIM Signature Validator Server 229. Although the App Notary Service Server 228 and SIM Signature Validator Server 229 are depicted as two physical machines, such separation is only for simplicity and no such physical separation is required. The App Notary Service Server 228 and SIM Signature Validator Server 229, in the examples, are application server software components for which functionality is implemented on one or more network connected computers.

Although FIG. 1 and the corresponding examples depict a single application server, such as server 231, as being connected via the Internet 230, such depiction is only for simplicity and the techniques described here apply to any number of application server(s), connected via the Internet 230 and/or via the Carrier Intranet 221. Each such application server 231, in the examples, is an instance of application server software components for which functionality is implemented on one or more network connected computers. The server application software running at 231 offers an on-line service that is consumed by client application programming on mobile devices like device 280 in our example.

As discussed more later, the mobile device 280 includes an identity chip or module, referred to here as a subscriber identity module (SIM). A similar module, for example, is sometimes referred to as a Universal Integrated Circuit Card (UICC).

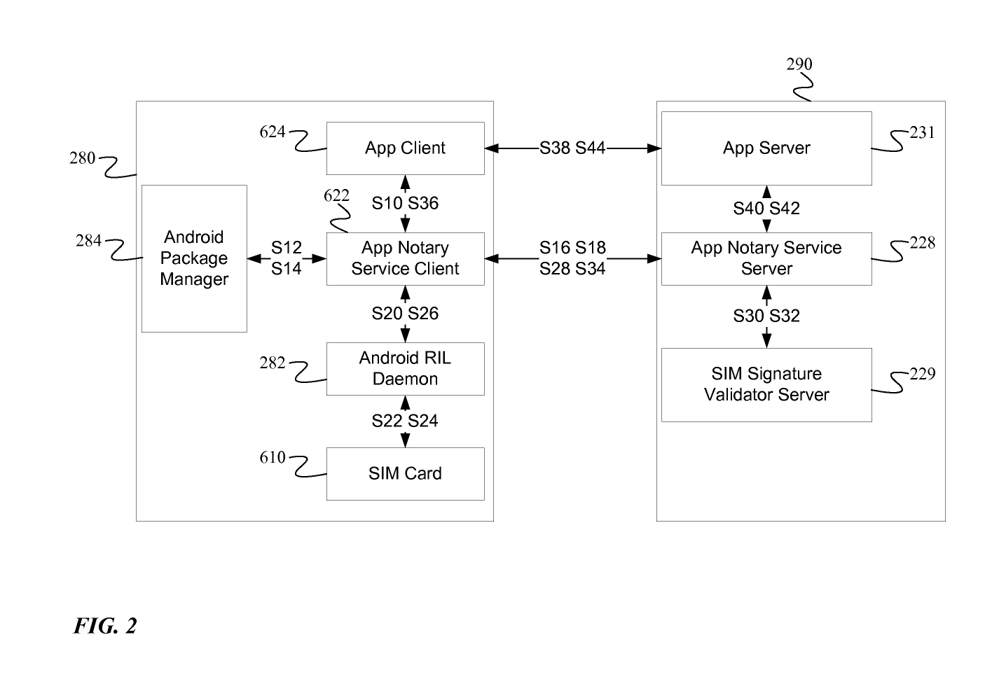

FIG. 2 shows a device, such as mobile device 280, communicating with a backend system 290. For convenience, the network or networks providing the communication connectivity, such as 220, 221, and/or 230, are omitted from FIG. 2. The backend system 290 may be implemented as a server application running or hosted on one or more network computer platforms. The drawing shows functional elements of the two devices in high-level block diagram form, to facilitate understanding of the mobile device application validation or ‘notary’ service under discussion here. Several of the elements of each device shown in FIG. 2 are implemented by programming running on processor(s) of the respective devices. Hardware examples that may run such programming will be discussed later, for completeness.

In the block diagram form, the backend system 290 includes an App Server 231, an App Notary Service Server 228 and a SIM Signature Validator Server 229. The App Server 231 is the server component for the App 1. The App Server 231 is typically implemented as server application programming on an appropriate programmable platform, such as a network connected computer. The App Server 231 provides a service that should be accessible only by the client programming for App 1. In an example, for a carrier operating a network providing communications to mobile devices of the carrier's customers, the App Server 231 might provide access to the customers' respective device usage data.

The App Notary Service Server 228 is the server component for the app notary service involved in authenticating or validating the appropriate corresponding application client for App 1. As described in greater detail below, the App Notary Service Server 228 receives notarization token requests, generates notarization tokens based on validated notarization token requests and validates notarization tokens submitted for validation by App Server 231. The SIM Signature Validator Server 229 is the server component that validates signatures created by the SIM Card 610 and provided in notarization token requests, as discussed below. In one example, the SIM Signature Validator Server 229 securely stores a symmetric key corresponding to the SIM Card 610. The correspondence between the stored symmetric key and the SIM Card 610 is, for example, based on an identifier of the SIM Card 610, the mobile device 280, the App Notary Service Client 622 and/or some other identifier uniquely associated with the SIM Card 610 and included in the notarization token request. This component can be separate or it can be bundled within the App Notary Service Server 228.

In the example, the mobile device 280 includes a SIM Card 610. The SIM Card 610 provides user account information and secure storage. A SIM Card 610 is a computer itself with internal processor and storage elements. As discussed more fully below, the SIM Card 610 will also provide information for validating a client application program.

For purposes of an example to consider in some detail, we will assume that the mobile device 280 is an Android type device running an iteration of the Android operating system. It should be understood, however, that the present teachings are applicable to other types of mobile devices running other operating systems, such as iOS, Windows Mobile, BlackBerry, etc. In our Android based example, the mobile device 280 includes an Android Package Manager 284 and an Android RIL Daemon 282. For any given application, such as App Client 622, installed on a mobile device, package information exists that includes, among other items, an application name (e.g., user-friendly identifier), a package name (e.g., an identifier defined by the application developer, such as application name and version information), and signing information (e.g., signing key(s) and corresponding certificate(s)). The Android Package Manager 284 records all installed apps on the device and the corresponding package information. The Android RIL Daemon 282 is the Radio Interface Layer (RIL) Daemon component in Android devices.

The mobile device 280, in our example, includes an App Client 624 and an App Notary Service Client 622. The App Client 624 is the application program client component that the service provider wants to allow to access its server component. In conjunction with App Server 231, App Client 624 provides an application service to the mobile device user. The App Notary Service Client 622 is the device client component of the app notary service involved in authenticating or validating the appropriate corresponding application client for App 1. App Notary Service Client 622 corresponds to and operates in conjunction with App Notary Service Server 228 to provide the app notary service under consideration here.

Although FIG. 2 and the corresponding examples depict an App Notary Service Client 622 connected to a single App Client 624 as well as an App Notary Service Server 228 connected to a single App Server 231, this is only for simplicity. In an example, an App Notary Service Client 622 is customized and/or otherwise limited to a single App Client 624. In an alternate example, App Notary Service Client 622 provides notary services on behalf of some number of otherwise different App Clients 624 with respect to one or more App Servers 231. Similarly, in one example, App Notary Service Server 228 only provides notary services on behalf of a single App Server 231. Alternatively, App Notary Service Server 228 provides notary services on behalf of some number of App Servers 231. In a further example, a first App Notary Service Client 622 and a first App Notary Service Server 228 provide notary services on behalf of a first App Client 624 or group or class of App Clients (not shown) and a first App Server 231 or group or class of App Servers (not shown) (e.g., App Client(s) and App Server(s) corresponding to application services provided by a carrier) while a second App Notary Service Client (not shown) and a second App Notary Service Server (not shown) provide notary services on behalf of a second App Client or group or class of App Clients and a second App Server or group or class of App Servers (not shown) (e.g., App Client(s) and App Server(s) corresponding to application services provided by a third party and/or group or class of third parties). In any of these examples, both the application service (app client 624 and app server 231) and the notary service (app notary service client 622 and app notary service server 228) may be operated and offered by a single entity (e.g., the operator/carrier of network 220) or the notary service (app notary service client 622 and app notary service server 228) may be operated by the operator of network 220 and offered for use by and on behalf of one or more other entities (e.g., application service provider(s)).

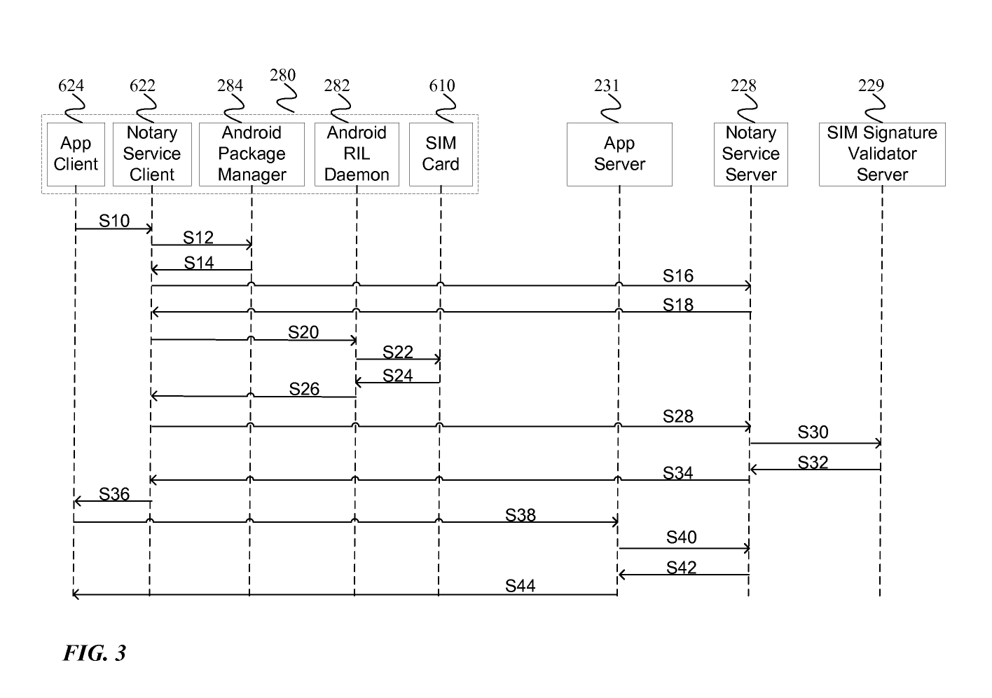

FIG. 2 includes numbered arrows to show steps of an example of a flow for processing of an application access request, with validation of client application via the notary server. FIG. 3 is a signal flow diagram showing those steps individually as signals passing back and forth amongst the various elements. The following description refers to the steps as shown in those alternate forms in the two drawings.

In step S10, the App Client 624 requests the App Notary Service Client 622 in a device 280 to provide notarization (certify its name) so that the App Client 624 can later authenticate itself to its server component App Server 231. An operating system (OS), Android in our example, maintains an identifier (ID) for each running application. Whenever a first application receives any request from a second application, the first application may request the ID of the second application from the OS. In addition to package information for all installed apps, the Android Package Manager 284 also maintains a map of each OS ID and the corresponding app. Upon receiving the notarization request, the App Notary Service Client 622 in step S12 asks for the ID of the calling process (the App Client 624 in our example) from the Android OS; and the App Notary Service Client 622 goes to the Android Package Manager 284 to ask for the corresponding package information (e.g., package name and signing information) of the calling application (the App Client 624). In step S14, Android Package Manager 284 provides the package name and signing information to App Notary Service Client 622 based on the calling process ID.

At step S16, the App Notary Service Client 622 requests a challenge from the App Notary Service Server 228 and, in step S18, the App Notary Service Server 228 provides a response to the challenge request. The response to the challenge request includes random data chosen by the App Notary Service Server 228 and a time stamp corresponding to the time the App Notary Service Server 228 generated the response. The App Notary Service Client 622 creates a notarization token request consisting of package information corresponding to App Client 624 and the response to the challenge request. In one example, the package information corresponding to App Client 624 is the package name and signing information of App Client 624. In one example, including the response to the challenge request (i.e., random data and time stamp) in the notarization token request, as well as subsequent exchanges between the App Notary Service Client 622 and App Notary Service Server 228 as described in more detail below, allows the app notary service (App Notary Service Client 622 and App Notary Service Server 228) to correlate requests and responses. Furthermore, including the time stamp in the response to the challenge request allows the app notary service, for example, to limit a validity timeframe, such as the amount of time elapsed between a notarization token request from the App Notary Service Client 622 and delivery of a notarization token from the App Notary Service Server 228 or the amount of time elapsed between delivery of a notarization token to App Client 624 and presentation of the notarization token by App Server 231 for validation. If such validity timeframe is exceeded, validation will fail, for example, and the notarization process must be completed again.

The App Notary Service Client 622, in step S20, sends the notarization token request (i.e., App Client 624 package name and signing information as well as the response to the challenge request from the App Notary Server 228) to the Android RIL Daemon 282; and the App Notary Service Client 622 asks the Android RIL Daemon 282 to send commands that make the SIM Card 610 sign the notarization token request. The Android RIL Daemon 282 is a trusted and privileged component of the Android OS. As such, any component that interacts with the Android RIL Daemon 282 must also be trusted and privileged. The App Notary Service Client 622 runs as a privileged app to be able to communicate with the Android RIL Daemon 282. That is, App Notary Service Client 622 is trusted by the operating system and therefore, by the Android RIL Daemon 282 and SIM Card 610. In step S22, the Android RIL Daemon 282 passes the smart card commands to the SIM Card 610.

The SIM Card 610 signs the notarization token request with a key stored in the SIM Card 610 and returns the signed notarization token request, in step S24, to the Android RIL Daemon 282. In one example, SIM Card 610 utilizes a symmetric key securely stored in the memory of SIM Card 610 to sign the notarization request. For example, SIM Card 610 passes the notarization token request through a hash function and encrypts the resulting hash value using the symmetric key. Thus, the signed notarization token request includes the notarization token request (i.e., App Client 624 package name and signing information as well as the response to the challenge request) and the corresponding signature generated by SIM Card 610

The Android RIL Daemon 282, in step S26, forwards the signed notarization token request to the App Notary Service Client 622. At step S28, the App Notary Service Client 622 passes the signed notarization token request to the App Notary Service Server 228 for validation. At this point in the process, the request sent to the App Notary Service Server 228 includes: the App Client 624 package name and the signing information from the manager 284; the response to the challenge request from the App Notary Service Server 228 (i.e., random data and the associated time stamp); and the signature generated by the SIM card 610. Although sent via network communication, it should be noted that this request is sent from App Notary Service Client 622 to App Notary Service Server 228, without going through the App Client 624 or the App Server 231.

In step S30, the App Notary Service Server 228 passes the signed notarization token request to the SIM Signature Validator Server 229 (which could be part of the App Notary Service Server 228). The signature created by the SIM Card 610 is validated by the SIM Signature Validator Server 229 and an indication of whether the notarization token request is valid is returned to the App Notary Service Server 228, as part of step S32. As discussed above in step S24, SIM Card 610 utilizes, in one example, a symmetric key securely stored in the memory of SIM Card 610 to sign the notarization request. In this example, SIM Signature Validator Server 229 also securely stores the same symmetric key corresponding to SIM Card 610. As discussed above, such symmetric key correspondence is based, for example, on an identifier of the SIM Card 610, mobile device 280, App Notary Service Client 622 and/or some other identifier uniquely associated with the SIM Card 610 and included in the notarization token request. The SIM Signature Validator Server 229, in step S30, utilizes the same symmetric key to also sign the notarization token request. In this example, SIM Signature Validator Server 229 passes the notarization token request through the same hash function and encrypts the resulting hash value using the same symmetric key. If the signature generated by the SIM Signature Validator Server 229 matches the signature provided in the signed notarization token request, the signed notarization token request is valid and taken as an indication that the identity information provided by App Client 624 (i.e., package name and signing information) is authentic and trustworthy. That is, SIM Signature Validator Server 229 is validating that the identity information provided by App Client 624 is authentic and properly belongs to App Client 624.

If the validation fails (i.e., the identity information provided by App Client 624 is not authentic and trustworthy), the process terminates and the App Notary Service Client 622 is unable to provide a notarization token to App Client 624. In one example, App Notary Service Client 622 waits a predetermined amount of time after sending the signed notarization token request to App Notary Service Server 228. If App Notary Service Client 622 fails to receive a notarization token from App Notary Service Server 228 within the predetermined amount of time, App Notary Service Client 622 provides, for example, an indication to the user of mobile device 280 of such time out. Alternatively, App Notary Service Client 622 receives, for example, an indication from App Notary Service Server 228 that validation failed, in which case App Notary Service Client 622 provides, for example, an indication of such failure to the user of mobile device 280 along with an indication that App Client 624 may not be authentic and trustworthy and/or otherwise inappropriate for use. Based on such indications (e.g., time out and/or validation failure notice), the user may choose to relaunch App Client 624, restart the notarization process and/or replace App Client 624 with an authentic and trustworthy client app.

If the validation is successful, the App Notary Service Server 228, in step S34, returns a notarization token to the App Notary Service Client 622, which in turn passes the notarization token, in step S36, to the App Client 624 for use in the future to prove its identity to the App Server 231.

At this point, the app notary service, via SIM Signature Validator Server 229, has validated that the identity provided by the App Client 624 to the App Notary Service Client 622 is consistent with an identity expected by the App Notary Service Server 228. The same notarization token request provided to the App Notary Service Server 228 by the App Notary Service Client 622 could be provided to the App Client 622 as a notarization token, however, any subsequent validation request from an App Server 231 would require the SIM Signature Validator Server 229 to perform the validation based on the corresponding symmetric key. This might unduly burden the SIM Signature Validator Server 229. In order to avoid the need to again use the SIM Signature Validator Server 229 in subsequent validation requests, the App Notary Service Server 228, for example, generates a notarization token based on the notarization token request, as described below.

In one example, the notarization token is the notarization token request (i.e., App Client 624 package name and signing information as well as the response to the challenge request) asymmetrically signed by the App Notary Service Server 228. That is, for example, the signature generated by the SIM Card 610 in the signed notarization token request is removed and replaced with a signature generated by the App Notary Service Server 228 in order to create the notarization token. In this example, the App Notary Service Server 228 generates a message digest of the notarization token request by utilizing a hashing function. The hashing function is, for example, SHA-1. The App Notary Service Server 228 then signs the notarization token request by encrypting the message digest utilizing the private key portion of a public key/private key pair of the App Notary Service Server 228. The App Notary Service Server 228 then forms the notarization token by concatenating the notarization token request and the asymmetric signature.

In an alternative example, the notarization token is the notarization token request (i.e., App Client 624 package name and signing information as well as the response to the challenge request) symmetrically signed by the App Notary Service Server 228. That is, for example, the signature generated by the SIM Card 610 in the signed notarization token request is removed and replaced with a signature generated by the App Notary Service Server 228 in order to create the notarization token. As with the previous asymmetric example, App Notary Service Server 228 generates a message digest of the notarization request. Unlike the asymmetric example, the App Notary Service Server 228 then signs the notarization request by encrypting the message digest utilizing a secret key held only by the App Notary Service Server 228. The App Notary Service Server 228 then forms the notarization token by concatenating the notarization request and the symmetric signature.

As noted, assuming a successful result of the SIM signature validation, the App Notary Service Server 228, in step S34, returns a notarization token to the App Notary Service Client 622, which in turn passes the notarization token to the App Client 624 in step S36. The notarization token, for example, includes: App Client 624 package name and signing information; the response to the challenge request; and the signature, either symmetric or asymmetric, generated by the App Notary Service Server 228. When the App Client 624 subsequently makes a request to App Server 231, in step S38, the App Client 624 also passes the notarization token created in step S34 as part of the request. At step S40, the App Server 231, depending on how the notarization token was created, requests validation of the notarization token.

If the App Notary Service Server 228 signed the notarization token request symmetrically with a secret key in step S34, the App Server 231 passes the notarization token to the App Notary Service Server 228, in step S40, for validation and, in step S42, the App Notary Service Server 228 provides the validation status back to the App Server 231. As discussed above in relation to step S30, the App Notary Service Server 228 validates the symmetrically signed notarization token by encrypting the original notarization token request portion of the token (i.e., App Client 624 package name and signing information as well as the response to the challenge request) utilizing the secret key held only by the App Notary Service Server 228. If the signature in the notarization token matches the newly generated signature, the notarization token is valid and taken as an indication that identity information provided by the App Client 624 to the App Server 231 is authentic and trustworthy. That is, the app notary service (App Notary Service Client 622 and App Notary Service Server 228) validates that the identity information provided by App Client 624 properly belongs to App Client 624 and has not been altered and/or spoofed prior to or during presentation to App Server 231. In this way, App Server 231 can trust that App Client 624 is an authentic application service client, in this example, one that should be allowed to request services from App Server 231.

If the App Notary Service Server 228 signed the notarization request asymmetrically with the private key portion of a public key/private key pair of the App Notary Service Server 228, the App Server 231 can, for example, perform the validation. In this scenario, the App Server 231 requests, in step S40, the public key portion of the public key/private key pair of the App Notary Service Server 228 from the App Notary Service Server 228 and, in step S42, the App Notary Service Server 228 provides the public key portion to the App Server 231. The App Server 231 then utilizes the public key portion to decrypt the signature generated with the private key portion. Based on the relationship between a public key portion and a private key portion of a public key/private key pair, an object encrypted with the private key portion can only be decrypted with the public key portion. The App Server 231 generates a message digest by hashing the original notarization token request portion of the notarization token (i.e., App Client 624 package name and signing information as well as the response to the challenge request). If the message digest generated by the App Server 231 matches the message digest generated by the App Notary Service Server 228 (i.e., decrypted signature utilizing the public key portion), the App Server 231 can validate that the notarization token was generated by the App Notary Service Server 228 and that the App Client 624 is a valid client.

Upon successful validation of the notarization token, the App Server 231 provides the service requested by the App Client 624 (step S44). In an alternative step S44, prior to providing the requested service, App Server 231 reviews, for example, the package name information provided in the notarization token to determine whether App Client 624 is the most recent version for interaction with App Server 231. A prior version of App Client 624 may contain, for example, a specific security hole and/or other programming related issue that makes the prior version unreliable and/or otherwise unacceptable for use in conjunction with App Server 231. App Server 231 maintains, for example, a list of unacceptable prior version(s) of App Client 624. Such list is maintained, for example, in a file, a database or otherwise in the memory of App Server 231. After the notarization token has successfully been validated, App Server 231 compares version information provided as part of the package name in the notarization token with the prior version information maintained by App Server 231. If App Client 624 is an unacceptable version, App Server 231 denies the connection request. In one example, App Server 231 provides an error message indicating the unacceptable version as part of the request denial to App Client 624 and App Client 624 displays the error message to the user and/or otherwise takes appropriate action to update to an acceptable version. If App Client 624 is an acceptable version, App Server 231 then provides the service requested by App Client 624.

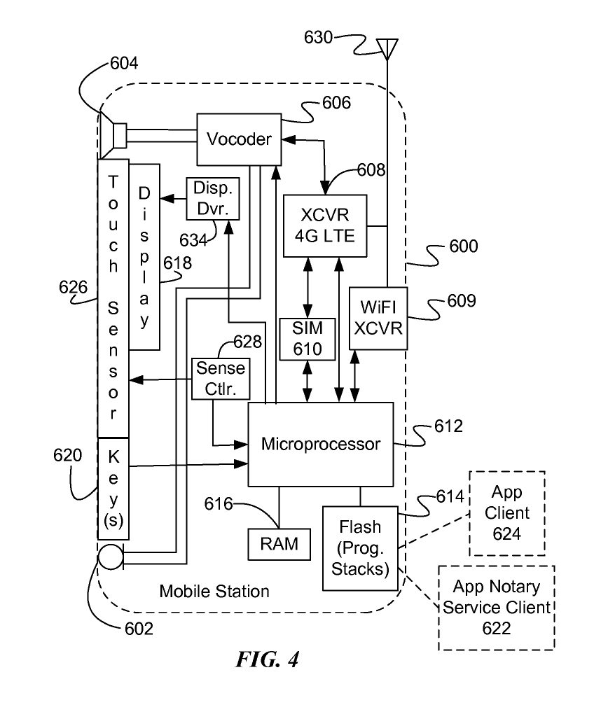

FIG. 4 provides a block diagram illustration of an exemplary mobile device 600, which may be used as the mobile device 280.

Although mobile device 600 may be a smart-phone or a tablet PC or may be incorporated into or connected to provide data communications for another device, such as a portable personal computer, personal digital assistant (PDA), etc., for discussion purposes, the illustration shows mobile device 600 in the form of a handset or feature phone. The handset example of the mobile device 600 functions as a normal digital wireless telephone station. For that function, the mobile device 600 includes a microphone 602 for audio signal input and a speaker 604 for audio signal output. The microphone 602 and speaker 604 connect to voice coding and decoding circuitry (vocoder) 606. For a voice telephone call, for example, the vocoder 606 provides two-way conversion between analog audio signals representing speech or other audio and digital samples at a compressed bit rate compatible with the digital protocol of wireless telephone network communications or voice over packet (Internet protocol) communications.

For digital wireless communications, mobile device 600 also includes at least one of digital transceivers (“XCVR”) 608 and 609. Mobile device 600 is a multimode device capable of operations on various technology type networks. The concepts discussed here encompass embodiments of the mobile device 600 utilizing any digital transceivers that conform to current or future developed digital wireless communication standards.

In the example, transceiver 608 is compatible with one or more standards of communication implemented in the public wide area mobile network 220. In particular, transceiver 608 supports 4G LTE wireless communications over airlinks with base stations 222. The same or a different transceiver (not shown) may also support one or more other standards of communication implemented in public mobile networks, such as CDMA, 1xRTT, EvDO, GSM or UMTS, e.g. for use when operating in areas where 4G LTE service may not be available. Transceiver 609 is compatible with one or more standards of communication implemented in wireless local area networks (WLANs), such as one of the WiFi standards and/or WiMAX.

Transceiver 608 provides two-way wireless communication of information, such as vocoded speech samples and/or digital message information, in a selected one of the technology modes. Transceiver 608 also sends and receives a variety of signaling messages in support of the various voice and data services provided via the mobile device 600 and the communication network. Each transceiver 608 connects through radio frequency (“RF”) send and receive amplifiers (not separately shown) to an antenna 610.

Transceiver 609 also provides two-way wireless communication of information, such as vocoded speech samples and/or digital message information, in a selected one of the technology modes. Transceiver 609 sends and receives a variety of signaling messages in support of the various voice and data services provided via the mobile device 600 and the communication network. Transceiver 609 connects through RF send and receive amplifiers (not separately shown) to an antenna 630. In the example, transceiver 609 is configured for RF communications in accord with a wireless LAN protocol (a hotspot), such as WiFi. For the network selection function, network communications via Transceiver 609 and antenna 630 may include detection of the available wireless LAN technology types in any given service area and selection of an available network for communications. Mobile device 600 may use transceiver 609 to communicate with a hotspot network, and may use transceiver 608 to communicate with cellular network 220.

The mobile device 600 may utilize a variety of different devices/technologies to implement user interface functions, for output of information to the user and input of information by the user. Many smartphones and tablets, for example, utilize touchscreen displays as (or as a part of) the user interface. For simplicity, however, the example in FIG. 2 utilizes a display and keypad.

Mobile device 600 therefore includes display 618, which microprocessor 612 controls via a display driver 634, for displaying messages, menus, call related information dialed by the user, calling party numbers, displaying applications, images, video, and web pages, etc. Displayed information may include responses and/or status provided by the App Client 624. The mobile device 600 also includes a touch/position sensor 626. The sensor 626 is relatively transparent, so that the user may view the information presented on the display 618. A sense circuit 628 sensing signals from elements of the touch/position sensor 626 and detects occurrence and position of each touch of the screen formed by the display 618 and sensor 626. The sense circuit 628 provides touch position information to the microprocessor 612, which can correlate that information to the information currently displayed via the display 612, to determine the nature of user input via the screen.

The display 612 and touch sensor 626 (and possibly one or more keys 620, if included) are the physical elements providing a textual or graphical user interface, in this simple example, including when executing programming such as the App Client 624 and/or aspects of the OS involving user interaction. User input/output may also be audible, e.g. via the microphone 602 and speaker 604. Various combinations of keypad 620, display 618, microphone 602 and speaker 604 may be used as the physical input output elements of the GUI, for multimedia (e.g. audio and/or video) communications. Other user interface elements may be used, such as a stylus and touch sensitive display screen, as in a PDA or smart phone.

Microprocessor 612 serves as a programmable controller for the mobile device 600, in that it controls all operations of mobile device 600 in accord with programming that it executes, for all normal operations, and for operations involved in providing notary services on behalf of App Client 624 running on mobile device 600. In the example, mobile device 600 includes flash type program memory 614, for storage of various “software” or “firmware” program routines and mobile configuration settings, including for the App Notary Service Client 622 and the App Client 624. The mobile device 600 may also include a non-volatile random access memory (RAM) 616 for a working data processing memory. Of course, other storage devices or configurations may be added to or substituted for those in the example. In a present implementation, the flash type program memory 614 stores firmware such as a boot routine, device driver software, an operating system, call processing software, App Notary Service Client 622, as described above, vocoder control software, and any of a wide variety of other App Client(s) 624 and/or applications, such as client browser software and short message service software. The memories 614 and 616 also store various data, such as telephone numbers and server addresses, downloaded data such as multimedia content, and various data input by the user. Programming stored in the flash type program memory 614, sometimes referred to as “firmware,” is loaded into and executed by the microprocessor 612 to configure the device to implement various device functions.

The mobile device 600 will store information needed to allow that device to operate over the network 220. Although other secure storage may be used, in the example, the device 600 includes a SIM card 610. The SIM card 610 in this example is a standardized module for secure storage of a variety of different information that may be used in communications with the network 220, for example, data identifying the mobile station to the network (e.g. IMSI, MDN and/or MIN). The SIM may also store policy or operation control information such as preferred roaming lists. The SIM card can also store, for example, a secret key, a user's private key, a public key, certificate or personal information. The information stored in the SIM card is tamper-resistant and secure. The SIM card 610 also contains an encryption engine that utilizes the stored keys to generate signatures, such as the notarization token request signature discussed above. Such encryption engine may be implemented as firmware and/or hardware within the SIM card 610.

The SIM card may include an interface circuit for communication with a mobile terminal in which the SIM card is installed, a control circuit, a flash memory, a ROM and a RAM. The flash memory, for example, may provide tamper resistant memory spaces, which can prevent unauthorized access to that memory space of the SIM card. For example, a SIM card may provide separate memory spaces for each application executable on the mobile terminal such that the memory space for one application is isolated and cannot be accessed by another application, by maintaining security domains in memory, as defined by the specification for SIM cards.

Information stored in the SIM card may be utilized for security, authentication or encryption purposes. For example, in addition to network authentication and authorization functions, the information in a SIM may be used for personal identification or for mobile payment. However, for security reasons, the SIM card is accessible only by a trusted server of the operator of the mobile communication service.

The SIM itself is identified by an ICCID. The ICCID includes a number up to 22 digits long including an issuer identification number, individual account identification and a check digit. The IMSI enables an operator of mobile communication network 220 (e.g., a wireless service carrier) to uniquely identify the subscriber on their network. The IMSI is tied to the corresponding telephone number so that a network of the mobile communication operator can connect phone calls with the mobile device that contains the SIM card by using the IMSI. The ICCID and/or IMSI, in one example, is included in any communication via network 220 and, as such, is utilized by the App Notary Server 228 and/or SIM Signature Validator Server 229 to identify the corresponding symmetric key during the notarization token request validation process described above in relation to FIG.

As shown by the discussion above, aspects of the application validation techniques may be implemented by appropriate programming of a mobile device and/or one or more server computers. FIG. 4 and the discussion thereof covered an example of a mobile device that may utilize relevant client side programming. It may be helpful to briefly consider computer platforms that may utilize relevant server side programming.

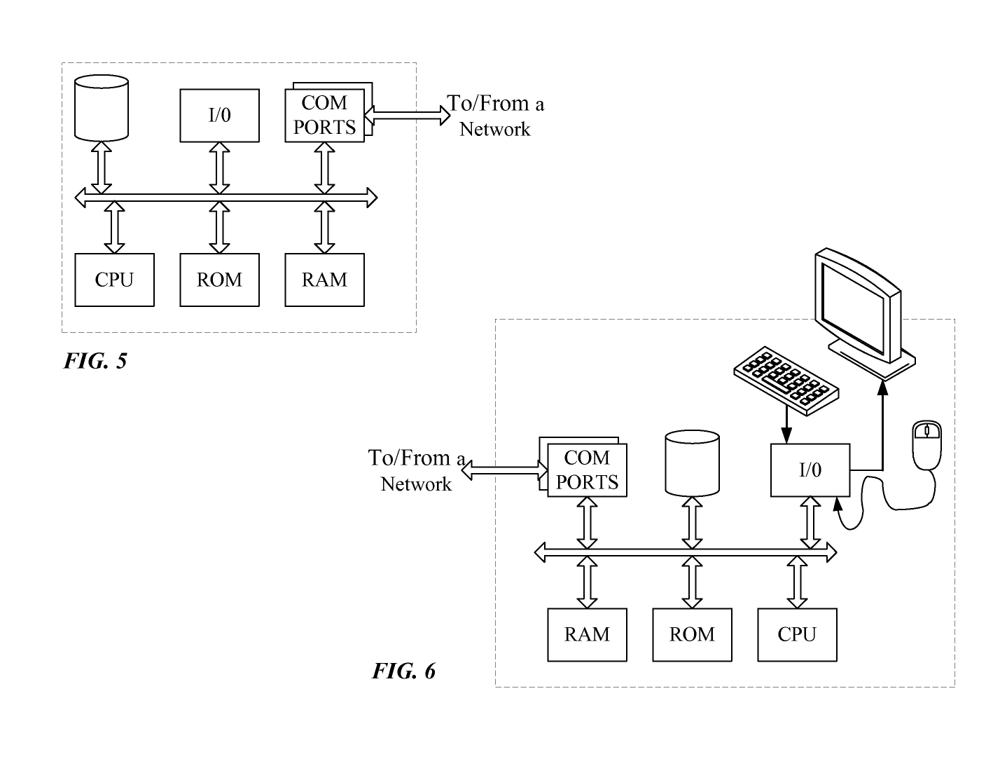

FIGS. 5 and 6 provide functional block diagram illustrations of general purpose computer hardware platforms. FIG. 5 illustrates a network or host computer platform, as may typically be used to implement a server. FIG. 6 depicts a computer with user interface elements, as may be used to implement a personal computer or other type of work station or terminal device, although the computer of FIG. 6 may also act as a server if appropriately programmed. It is believed that the general structure and general operation of such equipment as shown in FIGS. 5 and 6 should be self-explanatory from the high-level illustrations.

A computer for use as a server, for example, includes a data communication interface for packet data communication (see FIG. 5). The server also includes a central processing unit (CPU), in the form of one or more processors, for executing program instructions. The server platform typically includes an internal communication bus, program storage, and data storage for various data files to be processed and/or communicated by the server, although the server often receives programming and data via network communications. The hardware elements, operating systems and programming languages of such servers are conventional in nature, and it is presumed that those skilled in the art are adequately familiar therewith. Of course, the server functions may be implemented in a distributed fashion on a number of similar platforms, to distribute the processing load. The software programming relating to notary services techniques discussed herein may be downloaded and/or updated from a computer platform, for example, to configure the App Notary, SIM Signature Validator or other server (e.g. FIG. 1) or from a host computer or the like communicating with the mobile device (e.g. FIG. 4) via the network (e.g. FIG. 1) to download the App Notary Service application.

A computer type user terminal device, such as a PC or tablet computer, similarly includes a data communication interface CPU, main memory and one or more mass storage devices for storing user data and the various executable programs (see FIG. 6). A mobile device type user terminal may include similar elements, but will typically use smaller components that also require less power, to facilitate implementation in a portable form factor. The various types of user terminal devices will also include various user input and output elements. A computer, for example, may include a keyboard and a cursor control/selection device such as a mouse, trackball, joystick or touchpad; and a display for visual outputs. A microphone and speaker enable audio input and output. Some smartphones include similar but smaller input and output elements. Tablets and other types of smartphones utilize touch sensitive display screens, instead of separate keyboard and cursor control elements. The hardware elements, operating systems and programming languages of such user terminal devices also are conventional in nature.

Hence, aspects of the methods of notary service and related communications outlined above may be embodied in programming. Program aspects of the technology may be thought of as “products” or “articles of manufacture” typically in the form of executable code and/or associated list data that is carried on or embodied in a type of machine readable medium. “Storage” type media include any or all of the memory of the computers, processors or the like, or associated modules thereof, such as various semiconductor memories, tape drives, disk drives and the like, which may provide storage at any time for the software programming. All or portions of the software may at times be communicated through the Internet or various other telecommunication networks. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory or tangible storage media, more general terms such as computer or machine “readable medium” refer to any medium that participates in providing instructions to a processor for execution.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system, comprising:
a computer platform configured as a notary server, for a mobile application notary service; and
a computer platform configured as a validator server, for the mobile application notary service, wherein:
1) the notary server is configured to:
provide, through a mobile communication network to a notary client running on a mobile device a challenge response, responsive to a request from the notary client;
receive, through the mobile communication network from the notary client on behalf of an application client running on the mobile device, a notarization token request including information from the challenge response and information corresponding to the application client running on the mobile device; and
forward the notarization token request to the validator server;
2) the validator server is configured to:
determine whether the notarization token request is valid based on at least some of information contained within the notarization token request; and
advise the notary server of a valid validation status, when the notarization token request is determined to be valid; and
3) the notary server is further configured to:
based upon the valid validation status of the notarization token request provided by the validator server, provide a notarization token through the mobile communication network to the notary client;
receive, from an application server, a notarization token validation request corresponding to a request for service from the application client running on the mobile device and comprising a notarization token; and
when the received notarization token corresponds to the provided notarization token, indicate to the application server that the received notarization token is valid as an indication that the information corresponding to the application client running on the mobile device is valid.

2. The system of claim 1, wherein the notarization token request comprises:
challenge data from the response to the challenge request;
package information corresponding to the application client running on the mobile device; and
a notarization token request signature generated by an identity card of the mobile device based on the challenge data and package information.

3. The system of claim 2, wherein the validator server is further configured to:
generate a validation signature based on the challenge data and the package information corresponding to the application client running on the mobile device; and
determine that the notarization token request is valid in response to determining that the validation signature generated by the validator server matches the notarization token request signature generated by the identity card of the mobile device.

4. The system of claim 3, wherein the validator server is further configured to:
generate a hash of the challenge data and the package information corresponding to the application client running on the mobile device; and
generate the validation signature by encrypting the hash with a corresponding symmetric key shared in common by the validator server and the identity card of the mobile device,
wherein the validator server determines the corresponding symmetric key based on the package information corresponding to the application client running on the mobile device.

5. The system of claim 2, wherein the notarization token comprises:
the challenge data from the response to the challenge request;
the package information corresponding to the application client running on the mobile device; and
a notarization token signature generated by the notary server,
wherein the challenge data and the package information corresponding to the application client running on the mobile device are contained within the notarization token request received from the notary client.

6. The system of claim 5, wherein the notary server is further configured to generate the notarization token signature based on the challenge data and the package information corresponding to the application client running on the mobile device.

7. The system of claim 6, wherein the notary server is further configured to:
generate a hash of the challenge data and the package information corresponding to the application client running on the mobile device; and
generate the notarization token signature by encrypting the hash with a secret key known only by the notary server.

8. The system of claim 6, wherein the notary server is further configured to:
generate a hash of the challenge data and the package information corresponding to the application client running on the mobile device; and
generate the notarization token signature by encrypting the hash with a private key portion of a public key/private key pair of the notary server.

9. The system of claim 1, wherein:
the response to the challenge request comprises:
a time stamp; and
random data; and
the information corresponding to the application client comprises:
a package name; and
signing information of the application client.

10. A mobile device, comprising:
a communication interface system, including at least one wireless communication transceiver configured to communicate via a wireless communications network;
an identity module;
at least one user interface element configured to receive user input and to provide output to a user of the mobile device;
a processor coupled to the communication interface system and the at least one user interface element;
a memory;
an operating system stored in the memory;
an application client program stored in the memory; and
a notary client program stored in the memory, wherein execution of the notary client program by the processor configures the mobile device to perform functions, including functions to:
receive, by the notary client program, a request for a notarization token from the application client program;
obtain, by the notary client program and based on an identifier of the application client program provided by the operating system, package information corresponding to the application client program from a package manager of the operating system;
transmit, by the notary client program and via the wireless communications network, a challenge request to a notary server;
receive, by the notary client program and via the wireless communications network, a response to the challenge request from the notary server;
generate, by the notary client program, a notarization token request for signature by the identity module, the notarization token request including information from the challenge response and the package information;
sign, by the identity module and based on commands issued by the notary client program and delivered to the identity module via a radio interface layer daemon of the mobile device, the notarization token request;
send, by the notary client program and via the wireless communications network, the signed notarization token request to the notary server;
receive, by the notary client program and via the wireless communications network, a notarization token from the notary server; and
provide, by the notary client program, the notarization token to the application client program for inclusion in subsequent requests for service from an application server via the wireless communications network.

11. The mobile device of claim 10, wherein the notarization token request comprises:
the response to the challenge request; and
the package information corresponding to the application client program.

12. The mobile device of claim 10, wherein the signed notarization token request comprises:
the response to the challenge request;
the package information corresponding to the application client program; and
the signature generated by the identity module.

13. The mobile device of claim 10, wherein the implemented function to sign the notarization token request further includes functions to:
generate, by the identity module, a hash of the notarization token request; and
encrypt, by the identity module, the hash of the notarization token request with a symmetric key shared in common with the identity module and a validator server.

14. The mobile device of claim 10, wherein the notarization token comprises:
the response to the challenge request;
the package information corresponding to the application client; and
a notarization token signature generated by the notary server.

15. The mobile device of claim 10, wherein:
the response to the challenge request from the notary server comprises:
a time stamp; and
random data; and
the package information corresponding to the application client comprises:
a package name; and
signing information of the application client program.

16. A non-transitory machine-readable storage medium having instructions stored therein executable by a processor of a mobile device, wherein execution of the instructions by the processor configures the mobile device to perform functions, including functions to:
receive, by a notary client running on the mobile device, a request for a notarization token from an application client running on the mobile device;
obtain, by the notary client and based on an identifier of the application client provided by an operating system of the mobile device, package information corresponding to the application client;
transmit, by the notary client and via a wireless communications network, a challenge request to a notary server;
receive, by the notary client and via the wireless communications network, a response to the challenge request from the notary server;
generate, by the notary client, a notarization token request for signature by an identity module, the notarization token request including information from the challenge response and the package information;
obtain, by the notary client and from the identity module, a signed notarization token request;
send, by the notary client and via the wireless communications network, the signed notarization token request to the notary server;
receive, by the notary client and via the wireless communications network, a notarization token from the notary server; and
provide, by the notary client, the notarization token to the application client for inclusion in subsequent requests for service from an application server via the wireless communications network.

17. The storage medium of claim 16, wherein the notarization token request comprises:
the response to the challenge request; and
the package information corresponding to the application client.

18. The storage medium of claim 16, wherein the signed notarization token request comprises:
the response to the challenge request;
the package information corresponding to the application client; and
the signature generated by the identity module.

19. The storage medium of claim 16, wherein the notarization token comprises:
the response to the challenge request;
the package information corresponding to the application client; and
a notarization token signature generated by the notary server.

20. The storage medium of claim 16, wherein:
the response to the challenge request from the notary server comprises:
a time stamp; and
random data; and
the package information corresponding to the application client comprises:
a package name; and
signing information of the application client.
